(19) United States
(12) Patent Application Publication
(10) Pub. No.: US 2024/0316552 A1
(43) Pub. Date: Sep. 26, 2024

(54) MICROFLUIDIC DEVICE FOR CONCENTRATING TARGET PARTICLES IN A FLUID SAMPLE USING DIELECTROPHORESIS

(71) Applicant: QuantuMDx Group Limited, Newcastle Upon Tyne, Tyne and Wear (GB)

(72) Inventors: Eduardo BOADA ORTIZ, Newcastle Upon Tyne, Tyne and Wear (GB); Lothar SCHMID, Newcastle Upon Tyne, Tyne and Wear (GB); Heather MURTON, Newcastle Upon Tyne, Tyne and Wear (GB)

(21) Appl. No.: 18/575,009

(22) PCT Filed: Jun. 30, 2021
(86) PCT No.: PCT/GB2021/051658

§ 371 Date: Dec. 28, 2023

(51) Int. Cl. B01L 3/00

(52) U.S. Cl. CPC B01L 3/502761; B01L 2200/0652; B01L 2300/0645; B01L 2300/08; B01L 2400/0424; B01L 2400/084

(57) ABSTRACT

Disclosed herein is a microfluidic device for concentrating target particles in a fluid sample using dielectrophoresis (DEP). The microfluidic device comprises an inlet chamber comprising a fluid inlet for receiving a fluid sample, an outlet chamber comprising a fluid outlet for discharging the fluid sample, and a plurality of DEP channels. Each DEP channel is fluidically connected to the inlet chamber and to the outlet chamber such a fluid path from the fluid inlet to the fluid outlet is provided through each of the DEP channels, wherein the microfluidic device is configured such that each of the fluid paths has substantially the same fluid resistance.

### TECHNICAL FIELD

The present invention relates to microfluidic devices and associated methods for concentrating target particles in a fluid sample using dielectrophoresis (DEP).

### BACKGROUND

Microfluidic systems can be used to provide rapid point of care diagnosis of a health condition, such as an infection from a pathogen, from a fluid sample provided by a patient.

A microfluidic system for point of care testing typically comprises a microfluidic diagnostic device and a microfluidic cassette. A fluid sample from a patient is introduced into the microfluidic cassette and the microfluidic cassette is inserted into the microfluidic diagnostic device for processing. The microfluidic diagnostic device typically includes processing and sensing components, such as heaters, actuators and imaging sensors, that interact with the microfluidic cassette during testing. The microfluidic cassette typically includes a plurality of microfluidic channels for a fluid sample to pass through and interact with various reagents contained within the microfluidic cassette in a process controlled from outside the cassette by the microfluidic diagnostic device.

A problem that arises with microfluidic diagnostic systems is that it can be difficult to identify the presence of a target particle such as pathogen in a fluid sample when only a small amount of target particle is present. This can be particularly problematic when there is a need to perform a test quickly, such as in point of care settings, because a large volume of fluid sample may need to be processed to identify enough of a target particle to return a positive result. Processing a large volume of fluid sample can increase the time needed to perform a test.

It is known to use DEP techniques in a microfluidic device to concentrate target particles in a fluid sample to improve detection of target particles within the fluid sample. DEP is a process whereby a force is exerted on a dielectric particle by subjecting it to a spatially non-uniform electric field. Movement of a dielectric particle can be induced via DEP towards an electrode (positive DEP) or away from an electrode (negative DEP).

WO2017/220534 discloses a microfluidic device that uses DEP techniques to concentrate pathogens in a fluid sample. The device includes an array of DEP channels arranged in parallel, each DEP channel associated with one or more DEP electrodes. A fluid sample is passed through the array of DEP channels concurrently. The DEP electrodes selectively trap pathogens present in the fluid sample against walls of the DEP channels as the fluid sample passes through the DEP channels.

Using an array of DEP channels arranged in parallel to process a fluid sample rather than using a single DEP channel is advantageous because a fluid sample can be processed at a higher volumetric flow rate while maintaining desirable fluid flow characteristics (e.g., laminar rather than turbulent fluid flow) because the flow rate through each DEP channel can be reduced without reducing the overall flow rate through the device.

The device disclosed in WO2017/220534 uses a series of bifurcating inlet and outlet channels to direct a fluid sample through the parallel DEP channels. While useful for directing a fluid sample through multiple parallel DEP channels, the bifurcating inlet and outlet channels take up a large amount of surface area on the device and can involve channels being provided at different depths within the device. This can be disadvantageous because it can increase the size and cost of the device and the complexity of manufacturing the device. Providing a small, low-cost and easy to manufacture device is particularly important when the device is to be used in a point of care setting.

Further, the bifurcating inlet and outlet channels closest to the DEP channels have a small cross-sectional area. This can make the channels more difficult and expensive to manufacture. Still further, using the bifurcating inlet and outlet channels exposes a fluid sample passing through the device to a larger surface area of channel wall. This, combined with the low cross-sectional area of the bifurcating inlet and outlet channels, can increase adsorption of target particles present in the fluid sample to the channel walls, thereby reducing the sensitivity of a test performed on the fluid sample.

### SUMMARY OF THE INVENTION

In accordance with a first aspect of the invention there is provided a microfluidic device for concentrating target particles in a fluid sample using dielectrophoresis (DEP). The microfluidic device comprises: an inlet chamber comprising a fluid inlet for receiving a fluid sample; an outlet chamber comprising a fluid outlet for discharging the fluid sample; and a plurality of DEP channels. Each DEP channel is fluidically connected to the inlet chamber and to the outlet chamber such that a fluid path from the fluid inlet to the fluid outlet is provided through each of the DEP channels, wherein the microfluidic device is configured such that each of the fluid paths has substantially the same fluid resistance.

Optionally, the plurality of DEP channels are fluidically connected to the inlet chamber at spaced apart positions along an elongate portion of the inlet chamber and are fluidically connected to the outlet chamber at spaced apart positions along an elongate portion of the outlet chamber.

Optionally, the elongate portion of the inlet chamber and the elongate portion of the outlet chamber comprise respective elongate walls of the inlet chamber and the outlet chamber.

Optionally, the fluid inlet is positioned along the elongate portion of the inlet chamber before a first DEP channel of the plurality of DEP channels.

Optionally, the fluid inlet is positioned at an end of the inlet chamber.

Optionally, the fluid outlet is positioned along the elongate portion of the outlet chamber after a final DEP channel of the plurality of DEP channels.

Optionally, the fluid outlet is positioned at an end of the outlet chamber.

Optionally, the inlet chamber is shaped such that the fluid resistance increases from the fluid inlet along the elongate portion of the inlet chamber and the outlet chamber is shaped such that the fluid resistance decreases towards the fluid outlet along the elongate portion of the outlet chamber.

Optionally, the inlet chamber is shaped such that the cross-sectional area of the inlet chamber decreases from the fluid inlet along the elongate portion of the inlet chamber and the outlet chamber is shaped such that the cross-sectional area of the outlet chamber increases towards the fluid outlet along the elongate portion of the outlet chamber.

Optionally, the fluid resistance increases from the fluid inlet along the elongate portion of the inlet chamber by a corresponding amount as the fluid resistance decreases towards the fluid outlet along the elongate portion of the outlet chamber.

Optionally, an outer wall of the inlet chamber and/or an outer wall of the outlet chamber has a continuous curved shape along at least part of its length.

Optionally, the outer wall forms part of a fluid inlet or a fluid outlet.

Optionally, each of the fluid paths has substantially the same length.

Optionally, each DEP channel of the plurality of DEP channels has substantially the same fluid resistance.

Optionally, the microfluidic device is a microfluidic cassette.

Optionally, the fluid inlet is connected to a first microfluidic channel of the microfluidic device and the fluid outlet is connected to a further microfluidic channel of the microfluidic device such that a fluid sample can pass from the first microfluidic channel to the further microfluidic channel.

Optionally, each of the plurality of DEP channels comprises a microfluidic channel associated with one or more DEP electrodes, the one or more DEP electrodes arranged to selectively capture target particles flowing through the microfluidic channel.

In accordance with a second aspect of the invention there is provided a method of concentrating, on a microfluidic device, target particles in a fluid sample using dielectrophoresis (DEP). The method comprises: flowing a fluid sample from a fluid inlet of an inlet chamber to a fluid outlet of an outlet chamber via a plurality of fluid paths through a plurality of DEP channels that are fluidically connected to the inlet chamber and the outlet chamber, wherein the microfluidic device is configured such that each of the fluid paths has substantially the same fluid resistance.

Advantageously, in contrast with existing microfluidic devices that use a series of bifurcating inlet and outlet channels to direct a fluid sample through a plurality of DEP channels, microfluidic devices arranged in accordance with embodiments of the invention can avoid the need for bifurcating channels by fluidically connecting each of the DEP channels to an inlet chamber and an outlet chamber. The inlet chamber and the outlet chamber each define an enclosed space within the microfluidic device. The inlet chamber directs a fluid sample from a fluid inlet of the inlet chamber to an inlet of each of the DEP channels and the outlet chamber directs the fluid sample from an outlet of each of the DEP channels to a fluid outlet of the outlet chamber.

In this way, the DEP channels are connected in parallel across a common inlet chamber and outlet chamber. A plurality of fluid paths between the fluid inlet and the fluid outlet are provided via the respective plurality of DEP channels. The device is configured such that each of the plurality of fluid paths has substantially the same fluid resistance.

Advantageously, by virtue of the plurality of fluid paths having substantially the same fluid resistance, in use a fluid sample flows through each of the plurality of DEP channels at substantially the same volumetric flow rate. Further, using multiple DEP channels in parallel reduces the flow rate of fluid sample through each DEP channel. Advantageously, this can improve the fluid flow characteristics through the DEP channels by ensuring regular laminar fluid flow through each DEP channel and by preventing bubble formation. Improving the fluid flow characteristics through the DEP channels can, in turn, improve the ability of the DEP electrodes to capture target particles.

Further, the described advantageous fluid flow characteristics can be provided in a device that takes up significantly less surface area and in a manner that is simpler to manufacture compared with existing arrangements such as those that use a series of bifurcating inlet and outlet channels. Taking up less “footprint” can be particularly advantageous when the microfluidic device is used as part of a microfluidic cassette for use in a point of care setting because the microfluidic cassette can be made more compact and can be less complex and expensive to manufacture.

Advantageously, microfluidic devices arranged in accordance with embodiments of the invention can be easier and less expensive to manufacture than existing microfluidic devices because they do not need to include a series of narrow bifurcating inlet and outlet channels to feed a fluid sample to a plurality of DEP channels simultaneously.

Advantageously, a fluid sample passing through microfluidic devices arranged in accordance with embodiments of the invention is exposed to a small surface area of channel/chamber wall. This can improve the sensitivity of a test performed on a fluid sample by reducing the amount of adsorption of target particles present in the fluid sample to the channel/chamber walls.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 is a simplified schematic diagram of a microfluidic device in accordance with certain embodiments of the invention;

FIG. 2 is a simplified schematic diagram of a further microfluidic device in accordance with certain embodiments of the invention;

FIG. 3 is a simplified schematic diagram of the microfluidic device of FIG. 2 including a plurality of DEP electrodes in accordance with certain embodiments of the invention; and

FIG. 4 is a simplified schematic diagram of a further microfluidic device in accordance with certain embodiments of the invention.

### DETAILED DESCRIPTION

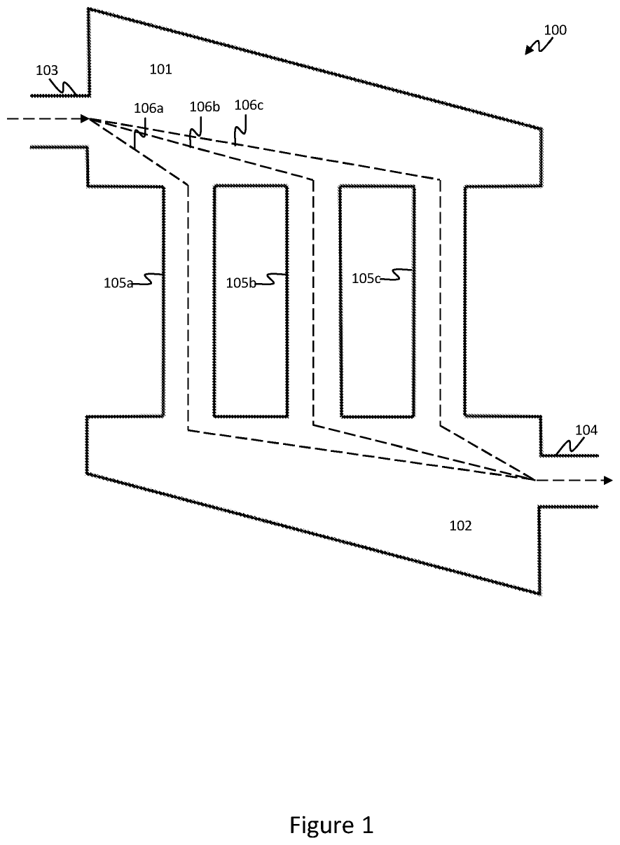

FIG. 1 is a simplified schematic diagram of a microfluidic device 100 in accordance with certain embodiments of the invention. The microfluidic device 100 is operable to concentrate target particles, such as pathogens, in a fluid sample using dielectrophoresis (DEP). The microfluidic device 100 can be part of a microfluidic cassette arranged to be inserted into a microfluidic diagnostic device for processing of a fluid sample present within the microfluidic cassette. It will be understood that typically the microfluidic device 100 includes further components needed for processing a fluid sample in addition to those shown in FIG. 1.

The microfluidic device 100 comprises an inlet chamber 101 and an outlet chamber 102. The microfluidic device 100 further comprises a first DEP channel 105a, a second DEP channel 105b and a third DEP channel 105c that are fluidically connected to the inlet chamber 101 and the outlet chamber 102.

The inlet chamber 101 comprises a fluid inlet 103 and the outlet chamber 102 comprises a fluid outlet 104. The fluid inlet 103 is located in an end wall of the inlet chamber 101 and the fluid outlet 104 is located in an end wall of the outlet chamber 102.

The inlet chamber 101 and the outlet chamber 102 each define an enclosed space within the microfluidic device 100.

The inlet chamber 101 is an elongate chamber. The inlet chamber 101 is shaped so that the fluid resistance increases from the fluid inlet 103 along an elongate portion of the inlet chamber 101 along which the plurality of DEP channels are connected. The elongate portion of the inlet chamber 101 extends between a first end of the inlet chamber 101 adjacent to the fluid inlet 103 and a second end of the inlet chamber 101 away from the fluid inlet 103. The fluid resistance increases along the elongate portion of the inlet chamber 101 by virtue of the first end of the inlet chamber 101 adjacent to the fluid inlet 103 having a larger cross-sectional area than the second end of the inlet chamber 101.

It will be understood that fluid resistance refers to the resistance to fluid flow through a region (also known as hydraulic impedance).

The outlet chamber 102 substantially corresponds with the inlet chamber 101. The outlet chamber 102 is shaped so that the fluid resistance decreases towards the fluid outlet 104 along an elongate portion of the outlet chamber 102 along which the plurality of DEP channels are connected. The elongate portion of the outlet chamber 102 extends between a first end of the outlet chamber 102 adjacent to the fluid outlet 104 and a second end of the outlet chamber 102 away from the fluid outlet 104. The fluid resistance decreases along the elongate portion towards the fluid outlet 104 by virtue of the first end of the outlet chamber 102 adjacent to the fluid outlet 104 having a larger cross-sectional area than the second end of the outlet chamber 102.

Typically, the inlet chamber 101 and the outlet chamber 102 substantially correspond in shape such that the fluid resistance increases from the fluid inlet 103 along the elongate portion of the inlet chamber 101 by a corresponding amount as the fluid resistance decreases towards the fluid outlet 104 along the elongate portion of the outlet chamber 102. As shown in FIG. 1, the outlet chamber 102 has a corresponding shape to the inlet chamber 101 but is rotated 180° relative to the inlet chamber 101 so that the fluid inlet 103 and the fluid outlet 104 are located on opposite sides of the microfluidic device 100.

The fluid inlet 103 is arranged to receive a fluid sample to allow the fluid sample to be introduced into the inlet chamber 101 and the fluid outlet 104 is arranged to allow the fluid sample to be discharged from the outlet chamber 102.

The fluid inlet 103 can be connected to a microfluidic channel of the microfluidic device 100 and the fluid outlet 104 can be connected to a further microfluidic channel of the microfluidic device 100. In use, as described in more detail below, the fluid inlet 103 and the fluid outlet 104 are used to pass a fluid sample into and out from the portion of the microfluidic device 100 shown in FIG. 1.

The first DEP channel 105a, second DEP channel 105b and third DEP channel 105c are microfluidic channels that are associated with one or more DEP electrodes (not shown) of the microfluidic device 100.

The first DEP channel 105a, second DEP channel 105b and third DEP channel 105c are arranged to perform DEP on a fluid sample passing therethrough. The DEP electrodes can be selectively activated when a fluid sample is passing through the plurality of DEP channels such that target particles, such as pathogens, can be selectively captured on a surface of the DEP channels associated with the DEP electrodes.

The first DEP channel 105a, second DEP channel 105b and third DEP channel 105c are each fluidically connected at a first end to the inlet chamber 101 and at a second end to the outlet chamber 102 such that fluid can pass from the inlet chamber 101 to the outlet chamber 102 via each of the plurality of DEP channels 105a 105b 105c. The plurality of DEP channels are fluidically connected to the inlet chamber 101 at spaced apart positions along an elongate portion of the inlet chamber 101 provided by an elongate wall of the inlet chamber 101. Similarly, the DEP channels are fluidically connected to the outlet chamber 102 at spaced apart positions along an elongate portion of the outlet chamber 102 provided by an elongate wall of the outlet chamber 102.

The plurality of DEP channels are fluidically connected to the inlet chamber 101 sequentially such that the first DEP channel 105a is positioned next to the fluid inlet 103, the second DEP channel 105b is positioned next to the first DEP channel 105a and the third and final DEP channel 105c is positioned next to the second DEP channel 105b and furthest away from the fluid inlet 103.

The plurality of DEP channels are fluidically connected to the outlet chamber 102 in the reverse order to the order with which the plurality of DEP channels are fluidically connected to the inlet chamber 101 relative to the fluid inlet and the fluid outlet. The third DEP channel 105c is positioned next to the fluid outlet 104, the second DEP channel 105b is positioned next to the third DEP channel 105c and the first DEP channel 105a is positioned next to the second DEP channel 105b and furthest away from the fluid outlet 104.

In this way, the DEP channel that is connected to the inlet chamber 101 at a position that is closest to the fluid inlet 103 is connected to the outlet chamber 102 at a position that is furthest away from the fluid outlet 104. Likewise, the DEP channel that is connected to the inlet chamber 101 at a position that is furthest from the fluid inlet 103 is connected to the outlet chamber 102 at a position that is closest to the fluid outlet 104.

FIG. 1 also shows a plurality of fluid paths for fluid to flow between the fluid inlet 103 and the fluid outlet 104.

A first path 106a is shown from the fluid inlet 103, through the inlet chamber 101, through the first DEP channel 105a, through the outlet chamber 102 to the fluid outlet 104.

A second path 106b is shown from the fluid inlet 103, through the inlet chamber 101, through the second DEP channel 105b, through the outlet chamber 102 to the fluid outlet 104.

A third path 106c is shown from the fluid inlet 103, through the inlet chamber 101, through the third DEP channel 105c, through the outlet chamber 102 to the fluid outlet 104.

The microfluidic device 100 is arranged such that the fluid resistance experienced by a fluid sample passing along each path 106a 106b 106c through the microfluidic device 100 is substantially the same by virtue of the shape and configuration of the inlet chamber 101 and the outlet chamber 102 and the order in which the plurality of DEP channels are fluidically connected to the inlet chamber 101 and the outlet chamber 102.

For example, a fluid sample passing along first path 106a is subject to a relatively small amount of fluid resistance in the inlet chamber 101 due to the short distance from the fluid inlet 103 to the entrance of the first DEP channel 105a and the larger cross-sectional area of the part of the inlet chamber 101 that the fluid sample passes through. Continuing along first path 106a, the fluid sample is subject to a relatively large amount of fluid resistance from the exit of the first DEP channel 105a through the outlet chamber 102 to the fluid outlet 104 due to greater distance from the exit of the first DEP channel 105a to the fluid outlet 104 and the smaller cross-sectional area of the part of outlet chamber 102 that the fluid sample passes through.

In contrast, a fluid sample passing along the second path 106b experiences a moderate amount of fluid resistance in the inlet chamber 101 and a moderate amount of fluid resistance in the outlet chamber 102, and a fluid sample passing along the third path 106c experiences a relatively large amount of fluid resistance in the inlet chamber 101 and a relatively small amount of fluid resistance in the outlet chamber 102. The microfluidic device 100 is arranged to provide substantially the same fluid resistance along each of the plurality of paths before and after the DEP channels. Typically, the DEP channels each have substantially the same fluid resistance.

In this way, the microfluidic device 100 provides substantially the same fluid resistance along each fluid path. Advantageously, this means that in use a fluid sample flows through each of the plurality of DEP channels at substantially the same volumetric flow rate. Advantageously, this can improve the fluid flow characteristics through the DEP channels by ensuring regular laminar fluid flow through each DEP channel and by preventing bubble formation. Improving the fluid flow characteristics through the DEP channels can, in turn, improve the ability of the DEP electrodes to capture target particles.

It will be understood that the fluid resistance along each fluid path can be determined by any suitable technique including suitable computation fluid dynamics (CFD) techniques.

Further, the microfluidic device 100 can provide such beneficial fluid flow characteristics while taking up significantly less surface area on the microfluidic device 100 compared with existing arrangements such as those that use a series of bifurcating inlet and outlet channels. This can be particularly advantageous when the microfluidic device 100 is part of a microfluidic cassette for use in a point of care setting because the microfluidic cassette can be made more compact and can be more cost effective to manufacture.

The microfluidic device 100 will now be described in use.

A fluid sample containing target particles such as pathogens is introduced into the inlet chamber 101 via the fluid inlet 103 and passes through the microfluidic device 100 via the first path 106a, the second path 106b and the third path 106c to the fluid outlet 104.

More specifically, the fluid sample passes from the fluid inlet 103 through the inlet chamber 101. Part of the fluid sample passes through each of the first DEP channel 105a, the second DEP channel 105b and the third DEP channel 105c. The fluid sample then passes from the first DEP channel 105a, the second DEP channel 105b and the third DEP channel 105c into the outlet chamber 102 and from the outlet chamber 102 out of the fluid outlet 104.

While the fluid sample is passing through the plurality of DEP channels, the DEP electrodes associated with the plurality of DEP channels are selectively activated such that target particles suspended in the fluid sample that is flowing through the plurality of DEP channels are captured by the electrodes and stick to a wall of the DEP channels associated with the electrodes.

The fluid sample continues to flow through the microfluidic device 100 while target particles are captured by the DEP electrodes. Subsequently, the electrodes are deactivated. This causes the target particles to be resealed into the fluid sample to provide a volume of fluid sample that is enriched with target particles. This enriched fluid sample can be directed, via the fluid outlet 104, for further processing.

A pump can be used to force the fluid sample between the fluid inlet 103 and the fluid outlet 104. The pump can be part of the microfluidic device 100 or an external component.

It will be understood that in other embodiments the microfluidic device 100 can include a different number of DEP channels and corresponding paths through the microfluidic device 100. It will further be understood that the fluid paths through the microfluidic device 100 are schematic and are intended depict the general direction of fluid flow through the microfluidic device 100.

The inlet chamber 101, outlet chamber 102, first DEP channel 105a, second DEP channel 105b and third DEP channel 105c are typically formed as recessed regions in a surface of a substrate. Typically, a sealing layer is secured over the substrate to fluidically seal the microfluidic device 100.

It will be understood that, in certain embodiments, the inlet chamber 101 and the outlet chamber 102 can take various suitable shapes and configurations to ensure the fluid resistance is balanced across the fluid paths through the device 100.

As described, DEP is a process whereby a force is exerted on a dielectric particle by subjecting it to a spatially non-uniform electric field. Movement of a dielectric particle can be induced via DEP towards an electrode (positive DEP) or away from an electrode (negative DEP).

It will be understood that the DEP electrodes disclosed herein are tuned appropriately to trap target particles using DEP when activated. For example, in some cases DEP electrodes can use 5 MHz at 17V (peak to peak) for capturing M. Smegmatis. However, it will be understood that the DEP electrodes can work over a range of suitable frequencies and voltages depending on flow-rates and electrode geometries.

In certain embodiments, each of the fluid paths can have substantially the same length through the microfluidic device 100.

The microfluidic device 100 (and other microfluidic devices described herein in accordance with embodiments of the invention) can be used to perform a method of concentrating, on a microfluidic device, target particles in a fluid sample using dielectrophoresis, the method comprising flowing a fluid sample from a fluid inlet of an inlet chamber to a fluid outlet of an outlet chamber via a plurality of fluid paths through a plurality of DEP channels that are fluidically connected to the inlet chamber and the outlet chamber, wherein the microfluidic device is configured such that each of the fluid paths has substantially the same fluid resistance. It will be understood that the method can include further steps and features as described herein.

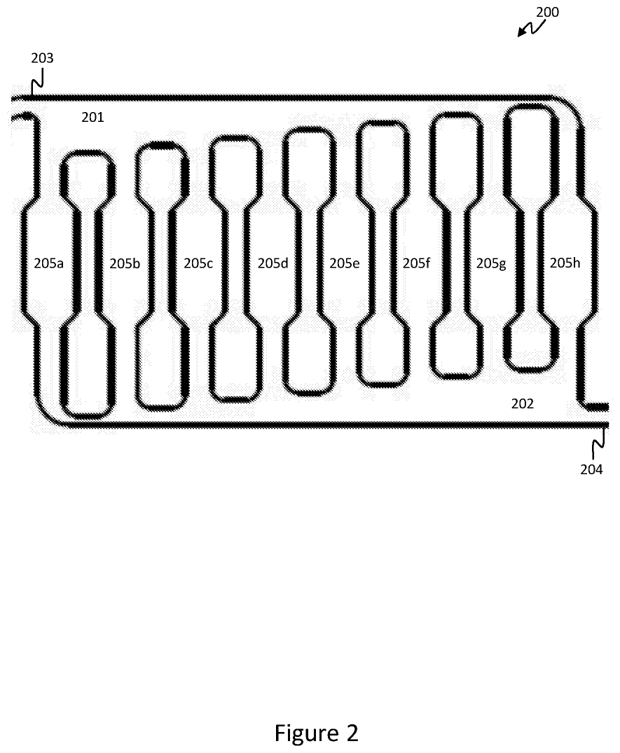

FIG. 2 is a simplified schematic diagram of a further microfluidic device in accordance with certain embodiments of the invention.

The microfluidic device 200 substantially corresponds with the microfluidic device 100 described with reference to FIG. 1 except as otherwise described and depicted.

The microfluidic device 200 comprises an inlet chamber 201 and an outlet chamber 202. The inlet chamber 201 comprises a fluid inlet 203 and the outlet chamber 202 comprises a fluid outlet 204.

The microfluidic device 200 comprises a first DEP channel 205a, a second DEP channel 205b, a third DEP channel 205c, a fourth DEP channel 205d, a fifth DEP channel 205e, a sixth DEP channel 205f, a seventh DEP channel 205g and an eighth DEP channel 205h. Each of the DEP channels is fluidically connected at a first end to the inlet chamber 201 and at a second end to the outlet chamber 202. Each of the DEP channels includes an inlet channel and an outlet channel on either side of a main channel.

The fluid inlet 203 is located at an end of the inlet chamber 201 adjacent to the first DEP channel 205a. The fluid outlet 204 is located at an end of the outlet chamber 202 adjacent to the eighth (and final) DEP channel 205h.

The inlet chamber 201 comprises an elongate outer wall and an elongate inner wall opposite to the outer wall. The plurality of DEP channels are connected along the inner wall. The inner wall and the outer wall are substantially straight. The inner wall is angled relative to the outer wall such that the inlet chamber 201 narrows from the fluid inlet 203 along the elongate portion of the inlet chamber 201 along which the plurality of DEP channels are connected.

The outlet chamber 202 comprises an elongate outer wall and an elongate inner wall opposite to the outer wall. The plurality of DEP channels are connected along the inner wall. The inner wall and the outer wall are substantially straight. The inner wall is angled relative to the outer wall such that the outlet chamber 202 widens towards the fluid outlet 204 along the elongate portion of the outlet chamber 202 along which the plurality of DEP channels are connected.

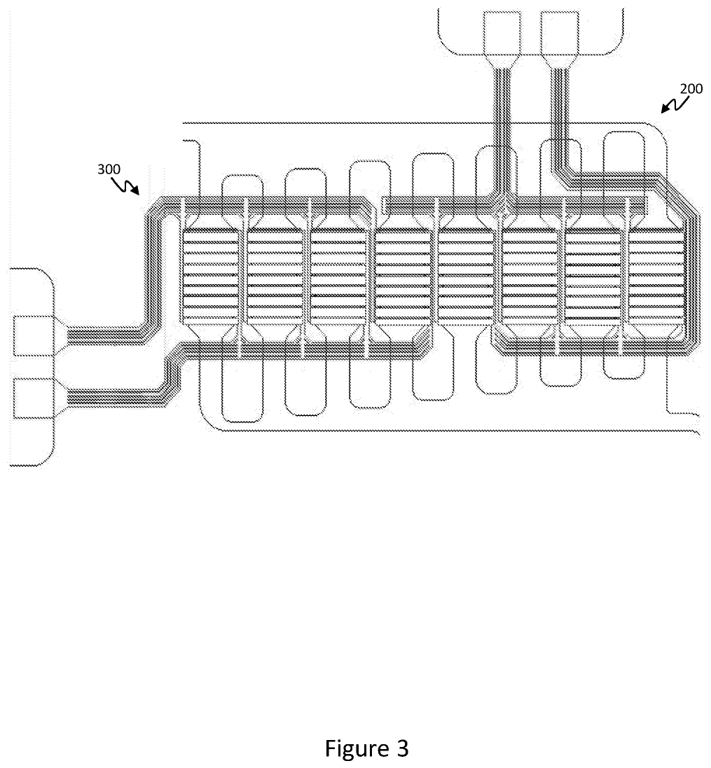

FIG. 3 is a simplified schematic diagram of the microfluidic device 200 of FIG. 2 including a plurality of DEP electrodes in accordance with certain embodiments of the invention.

The microfluidic device 200 includes a DEP electrode array 300. The DEP electrode array 300 comprises a plurality of electrodes that are positioned on or immediately adjacent to the DEP channels. As described herein, the DEP electrode array 300 can be selectively activated to capture target particles suspended in a fluid sample flowing through the DEP channels. The target particles are captured in the DEP channels immediately adjacent to the DEP electrodes. The DEP electrodes can be deactivated to allow the target particles to be released back into fluid flowing through the DEP channels.

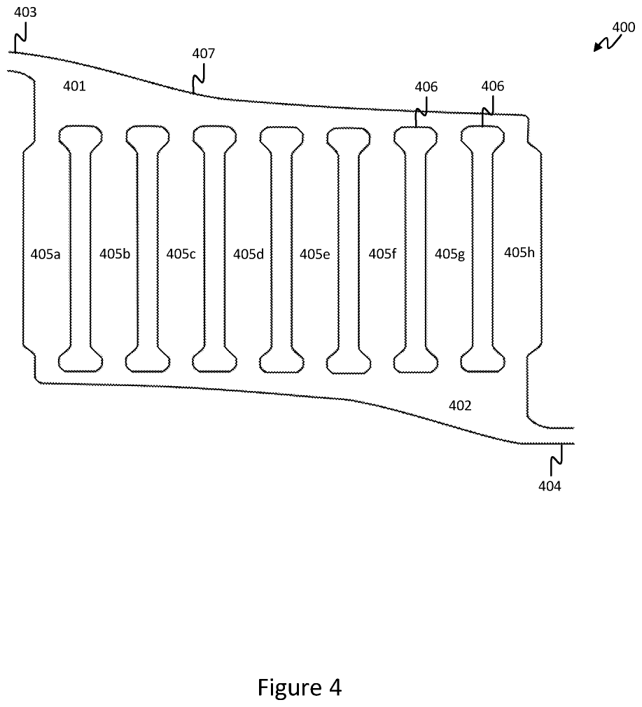

FIG. 4 is a simplified schematic diagram of a microfluidic device 400 in accordance with certain embodiments of the invention.

The microfluidic device 400 substantially corresponds with the microfluidic device 200 described with reference to FIG. 2 except as otherwise described and depicted.

The microfluidic device 400 comprises an inlet chamber 401 and an outlet chamber 402. The inlet chamber 401 comprises a fluid inlet 403 and the outlet chamber 402 comprises a fluid outlet 404.

The microfluidic device 400 comprises a first DEP channel 405a, a second DEP channel 405b, a third DEP channel 405c, a fourth DEP channel 405d, a fifth DEP channel 405e, a sixth DEP channel 405f, a seventh DEP channel 405g and an eighth DEP channel 405h.

The inlet chamber 401 comprises an elongate inner wall 406 and an elongate outer wall 407. Similarly, the outlet chamber 402 comprises an elongate inner wall and an elongate outer wall.

Each of the DEP channels is fluidically connected at a first end to the inlet chamber 401 and at a second end to the outlet chamber 402 in a spaced apart manner along the respective inner walls of the inlet chamber 401 and the outlet chamber 402.

In contrast with the microfluidic device 200 of FIG. 2, the outer wall 407 of the inlet chamber 401 has a continuous curved shape while the inner wall 406 of the inlet chamber 401 is substantially straight. At an end of the inlet chamber 401, the outer wall 407 forms part of the fluid inlet 403. The outlet chamber 402 has a corresponding shape.

In this manner, the internal surfaces of the inlet chamber 401 and the outlet chamber 402 that are exposed to a fluid sample are rounded. Advantageously, this can minimise turbulence at the inlets and outlets of each of the DEP channels resulting in smoother fluid flow and improving the local pressure drop characteristics across each of the DEP channels.

Advantageously, due to the shape of the inlet chamber 401 and the outlet chamber 402, the DEP channels can be made longer without increasing the overall size of the microfluidic device 400. Having longer DEP channels is advantageous because it can improve the ability of the DEP channels to trap target particles. Further, the inlet and outlet of each of the DEP channels has substantially the same length. This can further improve the regularity of fluid flow through each of the DEP channels.

In certain embodiments, the inlet chamber 401 is approximately 20 mm in length along the portion of the inlet chamber 401 to which the DEP channels are connected (in this embodiment, between a first end of the inlet chamber 401 adjacent to the fluid inlet 403 and a second end of the inlet chamber 401 furthest from the fluid inlet 403).

In certain embodiments, a first end of the inlet chamber 401 adjacent to the fluid inlet 403 has a width of between approximately 2.4 mm and 2.6 mm end and a second end of the inlet chamber 401 furthest from the fluid inlet 403 has a width of between approximately 0.4 mm and 0.5 mm. In certain embodiments, the inlet chamber 401 is approximately 0.06 mm deep.

In certain embodiments, the outlet chamber 402 has substantially the same dimensions as the inlet chamber 401.

It will be understood that an array of microfluidic devices of a type disclosed herein can be used to process a fluid sample. For example, an array of four microfluidic devices of a type disclosed herein can be used to process the same fluid sample. In such examples, part of the fluid sample can be fed into each of the devices. Using more than one microfluidic device to process a fluid sample can further improve target particle capture by further slowing the fluid flow through the DEP channels.

It will be understood that the target particles that can be captured by microfluidic devices arranged in accordance with embodiments of the invention can be pathogens (e.g. bacteria, virus or fungi) or other particles of interest such as proteins or cancerous cells.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A microfluidic device for concentrating target particles in a fluid sample using dielectrophoresis (DEP), the microfluidic device comprising:
an inlet chamber comprising a fluid inlet for receiving the fluid sample;
an outlet chamber comprising a fluid outlet for discharging the fluid sample; and
a plurality of DEP channels, each DEP channel fluidically connected to the inlet chamber and to the outlet chamber such that a fluid path from the fluid inlet to the fluid outlet is provided through each of the DEP channels, wherein each of the fluid paths has a fluid resistance that is substantially the same.

2. The microfluidic device according to claim 1, wherein the plurality of DEP channels is fluidically connected to the inlet chamber at spaced apart positions along an elongate portion of the inlet chamber and are fluidically connected to the outlet chamber at spaced apart positions along an elongate portion of the outlet chamber.

3. The microfluidic device according to claim 2, wherein the elongate portion of the inlet chamber and the elongate portion of the outlet chamber comprise respective elongate walls of the inlet chamber and the outlet chamber.

4. The microfluidic device according to claim 2, wherein the fluid inlet is positioned along the elongate portion of the inlet chamber before a first DEP channel of the plurality of DEP channels.

5. The microfluidic device according to claim 2, wherein the fluid inlet is positioned at an end of the inlet chamber.

6. The microfluidic device according to claim 2, wherein the fluid outlet is positioned along the elongate portion of the outlet chamber after a final DEP channel of the plurality of DEP channels.

7. The microfluidic device according to claim 2, wherein the fluid outlet is positioned at an end of the outlet chamber.

8. The microfluidic device according to claim 4, wherein the inlet chamber is shaped such that the fluid resistance increases from the fluid inlet along the elongate portion of the inlet chamber and the outlet chamber is shaped such that the fluid resistance decreases towards the fluid outlet along the elongate portion of the outlet chamber.

9. The microfluidic device according to claim 8, wherein the inlet chamber is shaped such that a cross-sectional area of the inlet chamber decreases from the fluid inlet along the elongate portion of the inlet chamber and the outlet chamber is shaped such that a cross-sectional area of the outlet chamber increases towards the fluid outlet along the elongate portion of the outlet chamber.

10. The microfluidic device according to claim 8, wherein the fluid resistance increases from the fluid inlet along the elongate portion of the inlet chamber by a corresponding amount as the fluid resistance decreases towards the fluid outlet along the elongate portion of the outlet chamber.

11. The microfluidic device according to claim 1, wherein one or both of an outer wall of the inlet chamber and an outer wall of the outlet chamber has a continuous curved shape along at least part of a length thereof.

12. The microfluidic device according to claim 11, wherein the outer wall forms part of the fluid inlet or the fluid outlet.

13. The microfluidic device according to claim 1, wherein each of the fluid paths has substantially the same length.

14. The microfluidic device according to claim 1, wherein each DEP channel of the plurality of DEP channels has a fluid resistance that is substantially the same.

15. The microfluidic device according to claim 1, wherein the microfluidic device is a microfluidic cassette.

16. The microfluidic device according to claim 1, wherein the fluid inlet is connected to a first microfluidic channel of the microfluidic device and the fluid outlet is connected to a further microfluidic channel of the microfluidic device such that a fluid sample can pass from the first microfluidic channel to the further microfluidic channel.

17. The microfluidic device according to claim 1, wherein each of the plurality of DEP channels comprises a microfluidic channel associated with one or more DEP electrodes, wherein the one or more DEP electrodes are arranged to selectively capture target particles flowing through the microfluidic channel.

18. A method of concentrating, on a microfluidic device, target particles in a fluid sample using dielectrophoresis (DEP), the method comprising:
flowing the fluid sample from a fluid inlet of an inlet chamber to a fluid outlet of an outlet chamber via a plurality of fluid paths through a plurality of DEP channels that are fluidically connected to the inlet chamber and the outlet chamber, wherein the microfluidic device is configured such that each of the fluid paths has a fluid resistance that is substantially the same.
